(19) United States
(12) Patent Application Publication
(10) Pub. No.: US 2014/0067506 A1
(43) Pub. Date: Mar. 6, 2014

(54) Apparatus and Method for Offering Micro Rewards in an Electronic Transmission

(71) Applicants: Carrie A. Hanson, Charlotte, NC (US); Hitesh Bajaj, Johns Creek, GA (US); Laura C. Bondesen, Charlotte, NC (US); Nicole Chen, San Francisco, CA (US); Scott R. Enscoe, Waxhaw, NC (US); David M. Grigg, Rock Hill, SC (US); Leo Kopelow, San Francisco, CA (US); Yameng Li, Berkeley, CA (US); Brett Newman, Burlingame, CA (US); Sarah Overcash, Charlotte, NC (US); Nicholas Sharp, San Francisco, CA (US); Marc L. Warshawsky, Davidson, NC (US); Alexander C. Wittkowski, Charlotte, NC (US); Jon R. Wolf, Charlotte, NC (US)

(72) Inventors: Carrie A. Hanson, Charlotte, NC (US); Hitesh Bajaj, Johns Creek, GA (US); Laura C. Bondesen, Charlotte, NC (US); Nicole Chen, San Francisco, CA (US); Scott R. Enscoe, Waxhaw, NC (US); David M. Grigg, Rock Hill, SC (US); Leo Kopelow, San Francisco, CA (US); Yameng Li, Berkeley, CA (US); Brett Newman, Burlingame, CA (US); Sarah Overcash, Charlotte, NC (US); Nicholas Sharp, San Francisco, CA (US); Marc L. Warshawsky, Davidson, NC (US); Alexander C. Wittkowski, Charlotte, NC (US); Jon R. Wolf, Charlotte, NC (US)

(73) Assignee: Bank of America Corporation, Charlotte, NC (US)

(21) Appl. No.: 13/602,789

(22) Filed: Sep. 4, 2012

(51) Int. Cl. G06Q 30/02

(52) U.S. Cl. 705/14.27

(57) ABSTRACT

According to one embodiment, an apparatus stores a user account and a points balance associated with the user account. The apparatus further determines a geographic location of a user associated with the user account. The apparatus then communicates, based at least in part upon the geographic location, an offer for a product. The produce may be associated with a points price and the points balance is at least equal to the points price. The apparatus then receives a signal indicating acceptance of the offer. The signal may be associated with the user account. The apparatus then communicates a second signal indicating that the user can receive the product.

### TECHNICAL FIELD

This disclosure relates generally to an apparatus for offering micro rewards in an electronic transmission.

### BACKGROUND

As the use of mobile devices grows, so has the desire to shift to the mobile devices tasks typically performed using other devices such as a personal computer in order to improve network efficiency and to reduce strain on computing resources. However, for certain tasks that have been traditionally performed on other devices, it may be difficult to encourage the user to perform these tasks on the mobile device due to technical challenges associated with mobile devices, communication networks, bandwidth, and computational resources.

### SUMMARY

According to one embodiment, an apparatus stores a user account and a points balance associated with the user account. The apparatus further determines a geographic location of a user associated with the user account. The apparatus then communicates, based at least in part upon the geographic location, an offer for a product. The produce may be associated with a points price and the points balance is at least equal to the points price. The apparatus then receives a signal indicating acceptance of the offer. The signal may be associated with the user account. The apparatus then communicates a second signal indicating that the user can receive the product.

In another embodiment, an apparatus communicates a geographic location of the apparatus and receives an offer for a product based at least in part upon the communicated geographic location. The product may be associated with a points price. The apparatus may present, on a display, the offer and the points price. The apparatus may detect a selection of the displayed offer indicating acceptance of the offer. The apparatus may then communicate a signal indicating acceptance of the offer and receive a second signal indicating that the acceptance is valid in response to a determination that a points balance is at least equal to the points price.

Certain embodiments may provide one or more technical advantages. A technical advantage of one embodiment includes more efficient usage of network resources. Leveraging geographic information in determining which offers to communicate to users may reduce the number of irrelevant or junk offers communicated over the network.

A technical advantage of another embodiment includes reduced strain on computing resources. Awarding points to users for performing particular tasks using mobile devices may encourage users to perform these tasks using their mobile devices, which reduces strains on more traditional computing resources.

Certain embodiments of the disclosure may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present disclosure and its features and advantages, reference is now made to the following description, taken in conjunction with the accompanying drawings, in which:

FIG. 1 illustrates a system for determining and presenting offers to a user;

FIG. 2 illustrates one embodiment of the device of FIG. 1 presenting offers associated with points prices;

FIG. 3 illustrates one embodiment of the device of FIG. 1 presenting offers and challenges with expiration times;

FIG. 4 illustrates one embodiment of the server of FIG. 1 maintaining a balance of points and communicating offers and challenges; and

FIG. 5 is a flowchart illustrating a method of determining and presenting offers to a user.

### DETAILED DESCRIPTION

This disclosure describes a system for awarding points to a user and for sending offers on which the user can spend those points. The system can award points to the user if the user performs particular transactions using a device such as a cell phone. The system can also send the user offers for products on which the user can spend points. These offers can be targeted based on the user's geographic location and can expire after a certain period of time. By allowing the user to earn points and to redeem those points for rewards, the system can encourage the user to use the cell phone to perform transactions.

Awarding points to the user may reduce processing strain by encouraging the user to adopt the use of the device to perform the particular transactions. In this manner, the system can steer users use less traditional devices to perform transactions, thereby reducing the processing strain on more traditional devices. For example, users may feel more comfortable performing a transaction such as a balance check on a personal computer or workstation. However, these devices may perform several other tasks. Performing the balance check on a less traditional device, such as a cell phone, may reduce the processing strain on the personal computer or workstation.

Furthermore, leveraging geographic location in presenting offers to the user may increase the efficient usage of network resources by reducing the number of irrelevant or junk offers communicated over the network. For example, if the system determines that the user is near a coffeeshop, the system may communicate an offer for that coffeeshop because the offer is more likely to be pertinent to the user at that time. In this manner, network resources may be more efficiently used.

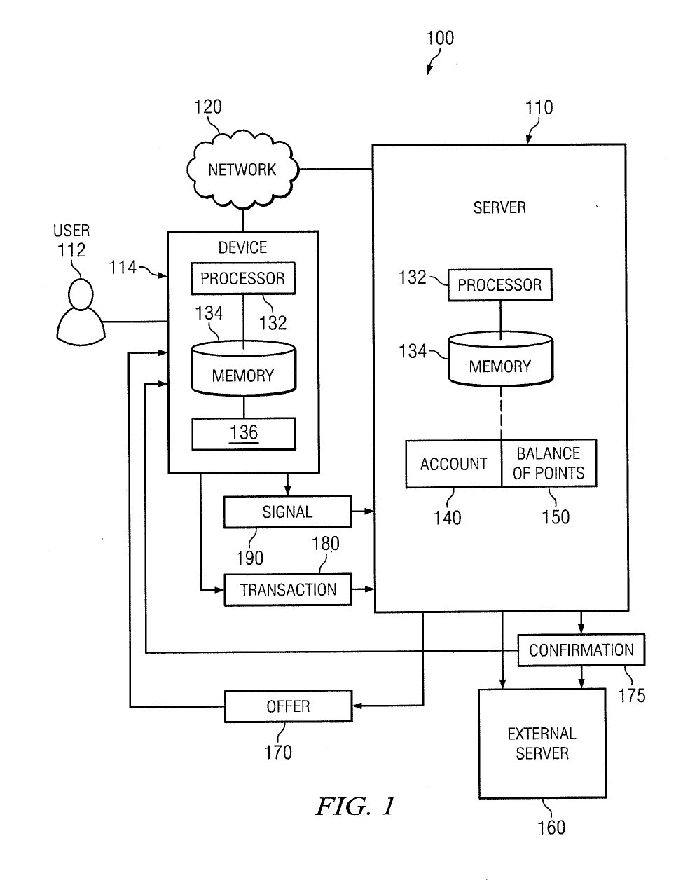

FIG. 1 illustrates a system 100 for determining and presenting offers 170 to a user 112. As provided by FIG. 1, server 110 may be communicatively coupled to device 114 and external server 160. In particular embodiments, server 110 may be communicatively coupled to external server 160 and device 114 through network 120.

In general, server 110 may add points 150 to an account 140 of the user 112 if the user 112 uses device 114 to perform particular transactions 180. For example, server 110 may add points 150 if the user 112 uses device 114 to perform a balance check or balance transfer. Server 110 may further communicate offers 170 on which user 112 can spend points 150. For example, server 110 may communicate an offer 170 for a cup of coffee to user 112 if the user 112 is near a coffeeshop. Device 114 may present the offers 170 on a display, and user 112 can select which offers 170 to accept.

System 100 may include device 114. Device 114 may be a mobile device such as a cell phone or tablet. Device 114 may be associated with a user 112. For example, user 112 may be an owner or custodian of device 114. User 112 may use device 114 to perform transactions 180. In particular embodiments, device 114 may communicate transactions 180 performed by user 112 to server 110. For example, user 112 may perform a balance check and device 114 may communicate to server 110 that user 112 has performed a balance check. In this manner, user 112 may use device 114 to initiate any appropriate transaction 180. These transactions 180 may be processed by server 110, and server 110 may then award points 150 to an account 140 of user 112.

Device 114 may receive offers 170 from server 110. In particular embodiments, these offers 170 may be based upon the geographic location of the user 112. Device 114 may use the global positioning system to communicate the geographic location of user 112 and/or device 114 to server 110. Server 110 may then communicate an offer 170 to device 114 based on the geographic location. For example, server 110 may determine that based on the received geographic location, user 112 and/or device 114 are near a particular store. Server 110 may then communicate to device 114 a buy-one-get-one-free offer for that store. User 112 can then select that offer 170 to indicate acceptance.

Device 114 may send signals 190 indicating an acceptance of offer 170. For example, user 112 may see offer 170 and decide to accept it. User 112 may perform an action, such as a button press or a touch on a touchscreen of device 114, to indicate acceptance of offer 170. Device 114 may then generate and send signal 190 indicating acceptance of offer 170 to server 110. After the user 112 accepts the offer 170, server 110 may deduct points 150 from the account 140 of the user 112. For example, the offer 170 may cost ten points. If the user 112 accepts the offer 170, server 110 will deduct ten points from the account 140 of the user.

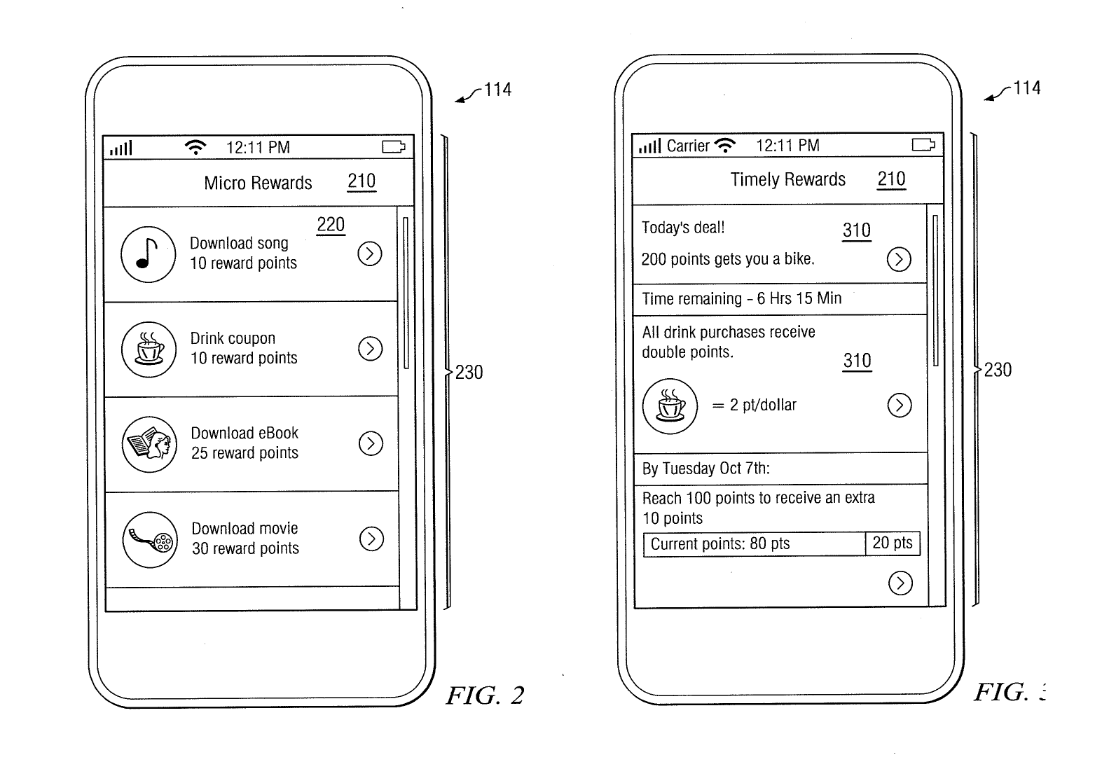

Device 114 may include a processor 132 and memory 134. The functions described herein may be performed by processor 132 and memory 134. In particular embodiments, memory 134 may store an application 136 that may be executed by processor 132. When executed, the application 136 may allow user 112 to interact with device 114 in order to perform the functions described herein. For example, the application 136 may cause device 114 to present offers 170 on a display of device 114. The application 136 may cause device 114 to further receive and communicate information associated with offers 170 to server 110. A more detailed description of the functions of the application 136 is provided in the description of FIG. 2.

Device 114 may be a personal computer, a workstation, a laptop, a wireless or cellular telephone, an electronic notebook, a personal digital assistant, a tablet, or any other device (wireless, wireline, or otherwise) capable of receiving, processing, storing, and/or communicating information with other components of system 100. Device 114 may also include a user interface, such as a display, a touchscreen, a microphone, keypad, or other appropriate terminal equipment usable by user 112.

System 100 may include network 120. Device 114 may communicate with server 110 through network 120. Server 110 may communicate with external server 160 through network 120. This disclosure contemplates any suitable network 120 operable to facilitate communication between the components of system 100. Network 120 may include any interconnecting system capable of transmitting audio, video, signals, data, messages, or any combination of the preceding. Network 120 may include all or a portion of a public switched telephone network (PSTN), a public or private data network, a local area network (LAN), a metropolitan area network (MAN), a wide area network (WAN), a local, regional, or global communication or computer network, such as the Internet, a wireline or wireless network, an enterprise intranet, or any other suitable communication link, including combinations thereof, operable to facilitate communication between the components.

Server 110 may be operable to communicate electronically with device 114. In particular embodiments, server 110 may include a processor 132 and memory 134. The functions described herein may be performed by processor 132 and/or memory 134. For example, memory 134 may store information associated with user 112 and/or device 114 such as account 140 and an associated balance of points 150. In particular embodiments, server 110 may store and update the balance of points 150 associated with account 140. For example, when user 112 performs a particular transaction, server 110 may increase the balance of points 150 of account 140 stored in memory 134. When user 112 accepts an offer 170, server 110 may decrease the balance of points 150 of account 140 stored in memory 134.

Memory 134 may store, either permanently or temporarily, data, operational software, or other information for processor 132. Memory 134 may include any one or a combination of volatile or non-volatile local or remote devices suitable for storing information. For example, memory 134 may include random access memory (RAM), read only memory (ROM), magnetic storage devices, optical storage devices, or any other suitable information storage device or a combination of these devices.

Processor 132 may determine a geographic location of user 112 and/or device 114. In particular embodiments, processor 132 may receive from device 114 the geographic location of user 112 and/or device 114. Processor 132 may use this geographic location to determine offers 170 that are pertinent to user 112. For example, processor 132 may determine that user 112 is near a bookstore. Processor 132 may then communicate to device 114 an offer 170 for a coupon to the bookstore. User 112 may then decide whether to accept or reject the offer 170.

Processor 132 may receive a signal 190 indicating acceptance of the offer 170. Signal 190 may be sent from device 114 after user 112 indicates acceptance of the offer 170. Using the previous example, user 112 may accept the offer 170 for the coupon to the bookstore by making a selection on device 114. Device 114 may then send signal 190 to server 110 indicating that user 112 has accepted the offer 170 for the coupon.

Processor 132 may then determine whether there are sufficient points 150 to accept the offer 170, and communicate a confirmation message 175. The offer 170 for the coupon may be associated with a points price of five points, meaning that user 112 cannot accept the offer 170 unless user 112 has at least five points in his account 140. After receiving signal 190, processor 132 may determine whether user 112 has at least five points in his account 140. If there are at least five points, processor 132 may deduct five points from the account 140 and send a confirmation message 175 to indicate that user 112 can receive the coupon. If there are not at least five points, processor 132 may deny the acceptance.

Processor 132 may control the operation and administration of server 110 by processing information received from network 120 and memory 134. Processor 132 may include any hardware and/or software that operates to control and process information. Processor 132 may be a programmable logic device, a microcontroller, a microprocessor, any suitable processing device, or any suitable combination of the preceding.

In particular embodiments, system 100 may include external server 160. External server 160 may be configured to communicate electronically with server 110. For example, server 110 may send signals such as confirmation message 175 to external server 160. Confirmation message 175 may indicate that user 112 can receive a product associated with the offer 170. In response to receiving confirmation message 175, external server 160 may process the product to be sent to user 112.

In operation, system 100 may incentivize user 112 to use device 114 to perform certain tasks. System 100 may add points 150 to an account 140 associated with user 112 in response to the user 112 performing a particular transaction 180 on device 114. For example, a balance check may be worth five points. When user 112 uses device 114 to perform a balance check, server 110 may add five points to an account 140 of user 112. Specifically, server 110 may determine that user 112 has performed a balance check and that a balance check is worth five points. Then server 110 may add five points to the account 140 of user 112. Although this disclosure describes user 112 performing particular types of transactions 180, this disclosure contemplates user 112 performing any appropriate type of transaction 180 including bill payments, money transfers, ATM transactions, setting appointments, and purchasing products or services. Each of these transaction types may be associated with a points value that server 110 may add to the balance of points 150 associated with account 140.

In particular embodiments, server 110 may determine offers 170 to present to user 112 based on the geographic location of user 112 and/or device 114. For example, device 114 may be configured to provide server 110 its geographic location based on the global positioning system. Based on the geographic location provided by device 114, server 110 may determine offers that are pertinent to user 112. For example, server 110 may determine that user 112 and/or device 114 is located near or within a predetermined distance of a particular store. In response to that determination, server 110 may communicate an offer associated with that store to user 112 through device 114. The offer 170 may include a product and a points price associated with the product. Device 114 may present the offer 170 to user 112. User 112 may decide to accept the offer 170. In response, device 114 may send server 110 a signal 190 indicating acceptance of the offer 170.

In particular embodiments, server 110 may determine offers 170 to present to user 112 based on previous transactions performed by user 112. Memory 134 may store the previous transactions performed by user 112 such as a previous purchase. For example, user 112 may have purchased a book for $20 from a particular bookstore. Memory 134 may store this information. Server 110 may use this stored information to determine offers 170 to present to user 112. For example, server 110 may use the information regarding the previous book purchase to determine an offer 170 for another related book. As another example, server 110 may use the information regarding the previous book purchase to determine an offer 170 for another item at the same bookstore. Although this disclosure describes server 110 storing information about a particular type of transaction, this disclosure contemplates server 110 storing information about any appropriate type of transaction. Although this disclosure describes server 110 determining particular types of offers based on the previous transaction, this disclosure contemplates server 110 determining any appropriate offer 170 based on the previous transaction.

Server 110 may receive signal 190 indicating an acceptance of the offer 170. In response, server 110 may determine whether particular conditions exist that would prevent the acceptance of offer 170. For example, server 110 may determine whether the account 140 of user 112 is associated with sufficient points 150 to accept the offer 170. As another example, server 110 may determine whether user 112 accepted the offer 170 before the offer 170 expired. If server 110 determined that the appropriate conditions have been met, then server 110 may send a signal such as confirmation message 175 indicating that user 112 can receive the product or service associated with the offer 170, server 110 may then send confirmation message 175 to device 114 and/or external server 160.

In particular embodiments, because system 100 awards points 150 to user 112 based on particular transactions 180 performed on device 114 and allows user 112 to spend those points 150 on offers 170, system 100 encourage user 112 to perform those particular transactions 180 on device 114. In this manner, system 100 may encourage and incentivize users 112 to overcome any fears or concerns with respect to performing these particular transactions 180 on device 114.

FIGS. 2 and 3 illustrate how the device 114 of FIG. 1 presents offers 170 to user 112. Generally, device 114 is a mobile device 114 with a display 230 that may be a touchscreen. Device 114 may receive offers 170 from server 110 and present these offers 170 on display 230. User 112 may then indicate an acceptance of an offer 170 by making a selection on device 114 through a button press or a touch.

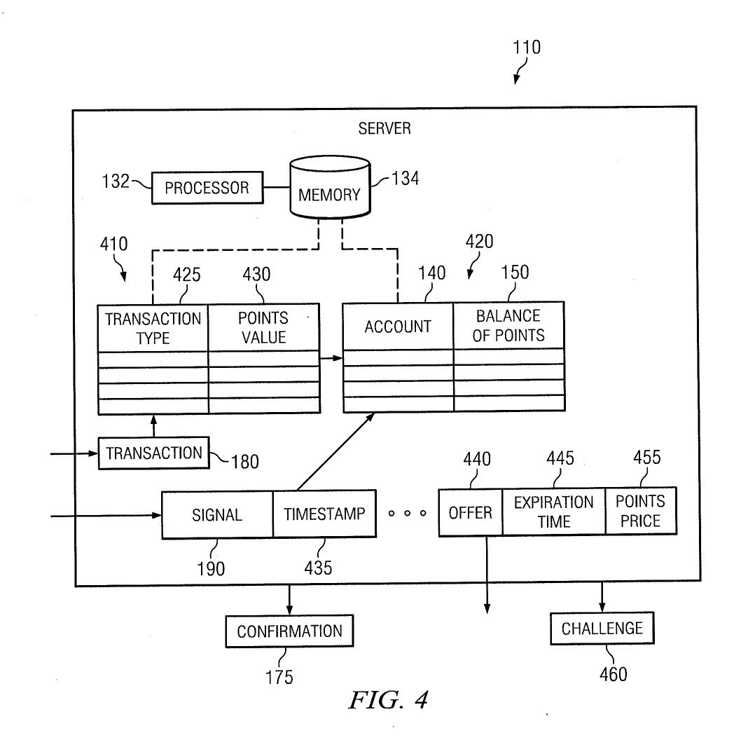

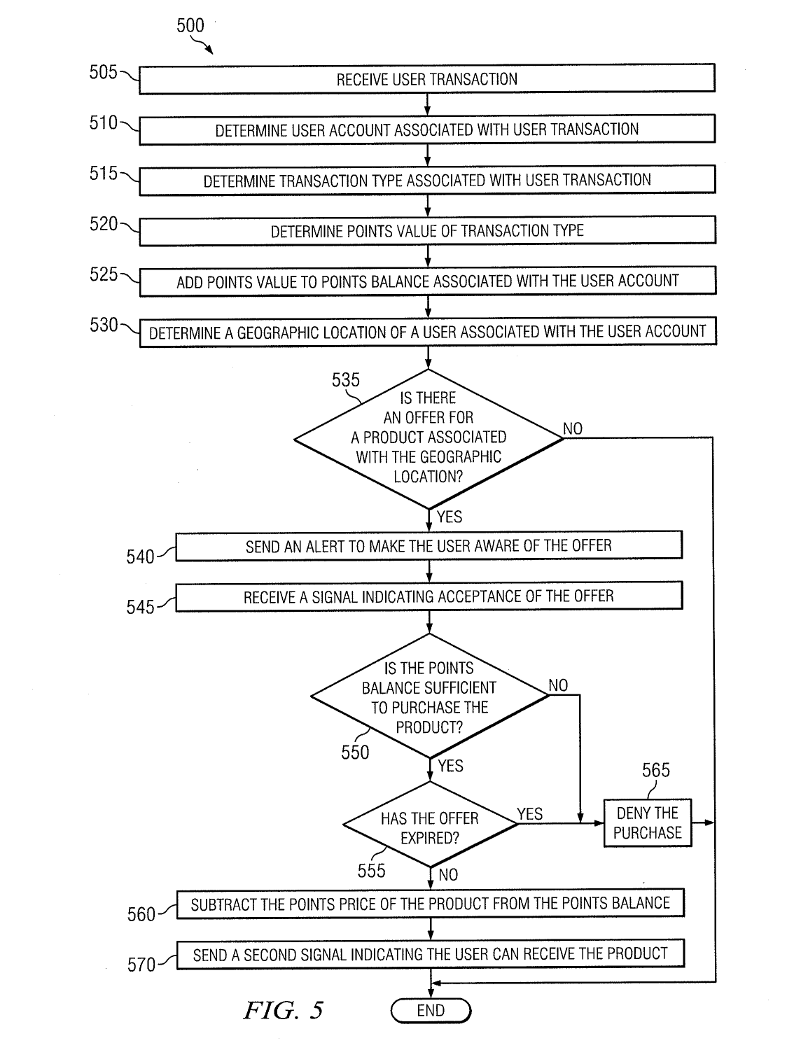

FIG. 4 illustrates the operation of the server 110 of FIG. 1. Generally, server 110 can add points to a balance of points 150 in response to the performance of a particular transaction 180 on device 114 or to the proper response to a challenge. Server 110 can deduct points from the balance of points 150 in response to the acceptance of particular offers 170. FIG. 5 is a flowchart illustrating a method 500 performed by server 110.

FIG. 2 illustrates one embodiment of the device 114 of FIG. 1 presenting offers 170 associated with points prices. Device 114 may be a mobile device 114 that includes a display 230. Device 114 may further include a processor 132 and a memory 134 that performs the functions described herein. Device 114 may be executing an application 136 that allows device 114 to perform the functionality described herein. For example, the images displayed on device 114 may be a result of executing application 136.

In particular embodiments, the memory 134 of device 114 may store an application that may be executed by the processor to perform the functions described herein. For example, the application may present offers 170 to user 112. When user 112 selects an offer 170 to accept, the application may communicate the acceptance to server 110. If server 110 confirms the acceptance of the offer 170, the application may present the confirmation on the display 230.

The application may communicate the geographic location of user 112 and/or device 114 to server 110. The application may use a global positioning system feature of device 114 to determine the geographic location of user 112 and/or device 114. The application may then send the geographic location to server 110 so that server 110 can determine any offers 170 that may be pertinent to user 112. For example, the application may determine the longitude and latitude of user 112 and/or device 114 using a global positioning system feature of the device 114. The server may send these coordinates to server 110 so that server 110 may determine offers 170 for stores near those coordinates.

The application may cause device 114 to present information on regions of display 230 for user 112 to see. A title may be displayed in a first region 210 of display 230. The title may provide context for the other items displayed on display 230. In a second region 220 of display 230, device 114 may display offers 170. In particular embodiments, offers 170 may be offers for products. For example, offer 170 may be an offer for a song, a coupon, an eBook, a gift certificate, and/or a movie. These products may have points prices associated with them. In the illustration of FIG. 2, a song has an associated points price of 10 points. A coupon also has an associated points price of 10 points, an eBook has an associated points price of 25 points, and a movie has an associated points price of 30 points. Although this disclosure describes system 100 offering certain types of products with certain associated points prices, this disclosure contemplates system 100 offering any appropriate product associated with any appropriate points price.

The application may cause device 114 to receive offers 170 from server 110. After server 110 determines the pertinent offers 170 based on the geographic location of user 112 and/or device 114, server 110 may communicate these offers 170 to device 114. In particular embodiments, device 114 may display offers 170 in second region 220 of display 230. Device 114 may further receive alerts from server 110 in order to make user 112 aware of the offers 170. Device 114 may display the offer 170 or notifications for the offer 170 in response to receiving the alert.

User 112 may accept a particular offer 170 by selecting the offer displayed in second region 220. For example, if device 114 comprises a touchscreen, user 112 may touch a portion of second region 220 to indicate acceptance of a particular offer 170. As another example, device 114 may comprise buttons that user 112 may push to indicate acceptance of a particular offer 170. Although this disclosure describes user 112 indicating acceptance of an offer 170 in a particular manner, this disclosure contemplates user 112 indicating acceptance of an offer 170 in any appropriate manner.

In particular embodiments, after user 112 indicates acceptance of a particular offer 170, the application may cause device 114 to send a signal 190 indicating acceptance of the offer 170 to server 110. In response, server 110 may then determine if an account 140 associated with user 112 has sufficient points 150 to purchase the product associated with the offer 170. For example, if user 112 accepts the offer 170 for a song with an associated points price of 10 points, server 110 may determine if the account 140 associated with user 112 has at least 10 points associated with it before allowing the acceptance. In particular embodiments, if there are sufficient points 150 associated with account 140, server 110 may generate and send a confirmation message 175 to device 114 or external server 160 indicating that user 112 can receive the product. In particular embodiments, if there are insufficient points 150 associated with account 140 to purchase the product, server 110 may issue an error message to device 114 indicating that there are insufficient points 150 associated with account 140. Device 114 may display the error message.

User 112 may perform transactions 180 using the application on device 114. For example, the application may allow user 112 to perform balance checks. When the user 112 performs the balance check, the application may cause device 114 to communicate the balance check to server 110. Server 110 may then add points to a balance associated with the account 140 of the user 112. In particular embodiments, the application may detect transactions 180 that are performed using another application on executing on device 114. The application may then cause device 180 to communicate the transaction 180 to server 110 even though user 112 performed the transaction 180 using another application. Other examples of transactions 180 may include bill payments, money transfers, ATM transactions, setting appointments, and making purchases.

Device 114 may receive an alert from server 110 regarding a particular offer 170. In particular embodiments, the application may detect the alert and cause device 114 to present on display 230 a notification or message indicating the offer 170. User 112 may be notified of the offer after seeing the notification or message. The application may further cause device 114 to make a noise or vibrate to notify the user of offer 170. For example, server 110 may determine that user 112 is near a bookstore and that there is an offer 170 associated with the bookstore. Server 110 may send an alert to device 114 to make user 112 aware of the offer 170. The application may detect this alert and cause device 114 to vibrate and to present on display 230 a message alerting user 112 of the offer 170 for the bookstore.

FIG. 3 illustrates one embodiment of the device 114 of FIG. 1 presenting offers 170 and challenges with expiration times. As in FIG. 2, device 114 may execute an application that performs the functions described herein. Device 114 may display in a third region 310 of display 230 offers 170. In particular embodiments, offers 170 may be further associated with an expiration time. For example, in the illustration of FIG. 3, device 114 is displaying an offer 170 for a bike for 200 points that expires in a day. Although this disclosure describes offers 170 for particular products associated with particular expiration times, this disclosure contemplates offers 170 for any appropriate products associated with any appropriate expiration time.

In particular embodiments, offers 170 may involve a points discount. For example, device 114 may display an offer 170 for a song at a discounted points price of five points when the song would normally cost 10 points. The offer 170 may be associated with an expiration time. For example, the discount points price for the song may expire in two hours. Server 110 may communicate an alert to device 114 to make user 112 aware of the discount points price. In response to receiving the alert, device 114 may display the discount points price to user 112. Although this disclosure describes device 114 displaying offers 170 for particular products at particular discount points prices expiring at particular expiration times, this disclosure contemplates offers 170 being for any appropriate product associated with any appropriate discount points price expiring at any appropriate expiration time.

In particular embodiments, device 114 may display an offer 170 for a points bonus for a particular transaction type. For example, as illustrated in FIG. 3, device 114 may display an offer 170 for double points for the purchase of a drink. In particular embodiments, offer 170 may be associated with an expiration time. In the example of FIG. 3, the double points offer expires in 6 hours and 15 minutes. In this example, if user 112 purchases a drink in the next 6 hours and 15 minutes user 112 will receive two points for every dollar spent on the drink where the user would normally receive one point per dollar spent on the drink. Although this disclosure describes offers 170 for a particular type of points bonus for purchasing a particular product and associated with a particular expiration time, this disclosure contemplates offers 170 for any appropriate points bonus for purchasing any appropriate product and associated with any appropriate expiration time.

In particular embodiments, device 114 may display a challenge issued by server 110. The challenge may be associated with a points reward and an expiration time. For example, in the illustration of FIG. 3, device 114 is displaying a challenge to reach 100 points. The reward for reaching 100 points is an extra 10 points. In the example, user 112 has accumulated 80 points. If user 112 accumulates another 20 points, user 112 will receive the extra 10 points. The challenge expires on Tuesday, October 7, meaning that user 112 should acquire the remaining 20 points before Tuesday, October 7, in order to receive the extra 10 points.

In particular embodiments, device 114 may display other types of challenges. For example, the challenge may involve a trivia question issued to multiple users 112. The first user 112 to supply the correct answer to the trivia question will receive the points reward. In another embodiment, the challenge may involve the performance of a task. The first user to perform the task may receive the points reward. For example, the challenge may be the first user 112 to perform ten balance checks receives the point reward. Although this disclosure describes particular types of challenges associated with particular types of rewards, this disclosure contemplates any appropriate challenge being associated with any appropriate reward type such as a reward of a product and/or a discount points price. Although this disclosure describes challenges associated with particular expiration times, this disclosure contemplates challenges being associated with any appropriate expiration times.

FIG. 4 illustrates one embodiment of the server 110 of FIG. 1 maintaining a balance of points 150 and communicating offers 170 and challenges 460. Server 110 may include a processor 132 and a memory 134. The functions described herein may be performed by processor 132 and/or memory 134 of server 110. In general, server 110 maintains balances of points 150 associated with accounts 140. Server 110 may add points 150 and/or subtract points 150 based on transactions 180 and acceptances 190.

In particular embodiments, server 110 tracks balances of points 150 associated with accounts 140 in table 420. Table 420 may include a plurality of accounts 140 associated with a plurality of users 112, and a plurality of balances of points 150 associated with the plurality of accounts 140. In particular embodiments, an account 140 may be associated with a credit card or debit card. When user 112 uses the credit or debit card, server 110 may associate those transactions with the account 140 of user 112.

In particular embodiments, server 110 may store particular transaction types 425 and their corresponding points values 430 in table 410. Server 110 may receive a transaction 180 and determine its transaction type 425. Server 110 may then use table 410 to determine the points value 430 corresponding to the transaction type 425 of transaction 180. Server 110 may determine the transaction type in table 410 that matches the transaction type of the transaction 180. Server 110 may then determine the corresponding points value 430 of the matching transaction type 425. Server 110 may further determine that transaction 180 is associated with a particular account 140 of user 112. Server 110 may then add the points value 430 to the balance of points 150 associated with the account 140. Server 110 may then update the balance of points 150 in table 420. As an example and not by way of limitation, server 110 may receive a transaction 180 and determine that it is a balance check. Server 110 may then use table 410 to determine that balance checks have a corresponding points value 430 of five points. Server 110 may then determine that the balance check was performed by a user 112 associated with a particular account 140. Server 110 may then add five points to the balance of points 150 associated with the account 140. Server 110 may then store the updated balance of points 150 in table 420. In this manner, server 110 may add points to the balances of points 150 based on the performance of particular transactions 180.

In particular embodiments, server 110 may determine an offer 440 for user 112. Server 110 may determine offer 440 based on the geographic location of user 112 and/or device 114. Device 114 may provide its geographic location to server 110 using the global positioning system. Based on the supplied geographical location, server 110 may determine offers 440 that are pertinent to the user's 112 location. As an example and not by way of limitation, server 110 may determine based on a supplied geographic location, that user 112 and/or device 114 is near or within a predetermined distance of a store associated with a merchant. The merchant may sell a particular product. Server 110 may further determine an offer 440 for the product sold by the merchant. Server 110 may then determine that based on the user's 112 and/or device's 114 geographic location that the offer 440 is pertinent to user 112. In response to this determination, server 110 may notify user 112 of the offer 440. In particular embodiments, server 110 may send an alert to device 114 in order to make user 112 aware of the offer 440. The alert may notify the user 112 that the offer 440 is available. In this manner, server 110 may determine offers 440 that are pertinent to user 112 and communicate these offers 440 to user 112.

In particular embodiments, offer 440 may be associated with an expiration time 445. The expiration time 445 may indicate a time at which offer 440 expires. In particular embodiments, user 112 should accept offer 440 before it expires in order for the acceptance to be valid. In other embodiments, server 110 should be notified of the acceptance before offer 440 expires in order for the acceptance to be valid.

In particular embodiments, offer 440 may be associated with a points price 455. Points price 455 may indicate the amount of points 150 to be subtracted from an account's 140 balance of points 150. For example, offer 440 may be for a song that has an associated points price of 10 points. When user 112 accepts offer 440, server 110 may subtract 10 points from an account 140 of user 112.

After server 110 makes user 112 aware of offer 440, server 110 may receive a signal 190 indicating acceptance of offer 440. The signal 190 may be sent from device 114 in response to user 112 indicating acceptance of an offer 440. In particular embodiments, the signal 190 may be associated with a timestamp 435. Timestamp 435 may indicate a time at which user 112 accepted offer 440. In other embodiments, timestamp 435 may indicate the time at which server 110 received the signal 190.

In particular embodiments, when server 110 receives signal 190 indicating acceptance of offer 440, server 110 may validate the acceptance by determining whether particular conditions have been met. For example, server 110 may determine whether an account 140 associated with user 112 has sufficient points 150 to accept offer 440. Server 110 may make this determination by comparing the balance of points 150 associated with account 140 with points price 455. If the balance of points 150 is at least equal to the points price 455, then there are sufficient points 150 to accept offer 440. If the balance of points 150 is less than the points price 455, server 110 may determine that there insufficient points 150 to accept offer 440. Server 110 may further communicate a message to device 114 indicating that the offer 440 cannot be accepted because there are insufficient points 150 to accept the offer 440.

As another example, server 110 may determine that the offer 440 had not expired at the time user 112 accepted the offer 440. In particular embodiments, server 110 may compare timestamp 435 with expiration time 445 to determine whether user 112 accepted the offer prior to the expiration of offer 440. In another embodiment, server 110 may determine whether it received signal 190 indicating acceptance of offer 440 prior to offer 440 expiring. Server 110 may again compare timestamp 435 with expiration time 445 to determine whether server 110 received signal 190 prior to the expiration of offer 440. If the offer 440 had expired, server 110 may communicate a message to device 114 indicating that the acceptance was not timely.

In particular embodiments, after server 110 validates the acceptance of the offer 440, server 110 may subtract the points price 455 from the balance of points 150 associated with account 140 of user 112. Server 110 may further generate and send confirmation message 175 indicating that user 112 can receive the product associated with offer 440. In particular embodiments, server 110 may send confirmation message 175 to device 114 and/or external server 160.

In particular embodiments, server 110 may issue a challenge 460. As described previously, challenge 460 may include a trivia question and/or a task to be performed. Server 110 may issue challenge 460 periodically according to a predetermined period of time. For example, server 110 may be configured to issue a challenge 460 daily, weekly, monthly, or any other appropriate period of time. Server 110 may receive a response to challenge 460 from user 112. For example, if challenge 460 is a trivia question, server 110 may receive signal 190 from user 112 providing an answer to the trivia question. Server 110 may then determine if the provided answer is the correct answer to the trivia question. If the provided answer is the correct answer, server 110 may provide a reward to user 112 or an account 140 associated with user 112. For example, server 110 may add a reward of points to the balance of points 150 associated with account 140 of user 112. As another example, server 110 may send a reward certificate or a coupon to device 114 to be used by user 112.

As another example, server 110 may issue a challenge 460 that includes a task to be performed. The task to be performed may be in the form of a particular transaction type 425. For example, server 110 may issue a challenge 460 that provides a reward to the first user 112 that performs ten balance checks. Server 110 may then track the transactions 180 from users 112 that are of a balance check transaction type 425. When server 110 determines that user 112 is the first user 112 to perform ten balance checks, server 110 may provide the reward to user 112. Again, server 110 may provide a reward in the form of adding points 150 to an account 140 associated with user 112 or send a reward certificate or coupon to device 114 to be used by user 112. Although this disclosure describes server 110 sending particular products to device 114 for properly responding to the challenge 460, this disclosure contemplates server 110 sending any appropriate product to device 114 for properly responding to the challenge. For example, server 110 may send a cash back offer. Furthermore, server 110 may also add a points bonus to the balance of points 150 for properly responding to the challenge.

FIG. 5 is a flowchart illustrating a method 500 of determining and presenting offers 440 to a user 112. Server 110 may be configured to perform method 500. In step 505, server 110 may begin by receiving a user transaction 180. In step 510, server 110 may determine the user account 140 associated with the user transaction 180. Server 110 may then determine the transaction type 425 associated with the user transaction 180 in step 515. Server 110 may then determine a points value 430 associated with the transaction type 425 in step 520. In particular embodiments, server 110 may use a table 410 to determine the associated points value. In step 525, server 110 may add the points value 430 to the points balance 150 associated with the user account 140. In this manner, server 110 may determine and add particular point values to the balance of points 150 associated with account 140 in response to user 112 performing certain transactions 180.

In step 530 server 110 may determine a geographic location of user 112 associated with user account 140. In particular embodiments, server 110 may be provided the geographic location by device 114. Device 114 may use the global positioning system to provide its geographic location to server 110. In step 535 server 110 may determine whether there is an offer 440 for a product associated with the geographic location. If there is not an offer 440 associated with the geographic location, server 110 may conclude. If there is an offer 440 associated with the geographic location, server 110 may send an alert to make user 112 aware of the offer 440 in step 540. In particular embodiments, user 112 may be made aware of the offer and may accept the offer using device 114. In response, server 110 may receive a signal 190 indicating acceptance of the offer 440 in step 545. Server 110 may then validate the acceptance of the offer 440 by determining whether particular conditions have been met.

In step 550 server 110 may determine whether there are sufficient points associated with account 140 to purchase the product associated with offer 440. If there are not sufficient points, server 110 may conclude by denying the purchase in step 565. If there are sufficient points, server 110 may then determine in step 555 whether the offer 440 had expired. If the offer 440 had expired, server 110 may conclude by denying the purchase in step 565. If the offer had not expired, then server 110 may continue to step 560 to subtract the points price of the product from the points balance 150 associated with user account 140. Server 110 may then conclude by sending a second signal such as confirmation message 175 indicating that the user 112 can receive the product in step 570. In particular embodiments, server 110 may send the second signal to device 114 and/or external server 160.

Although the present disclosure describes several embodiments, a myriad of changes, variations, alterations, transformations, and modifications may be suggested to one skilled in the art, and it is intended that the present disclosure encompass such changes, variations, alterations, transformations, and modifications as fall within the scope of the appended claims.

What is claimed is:

1. An apparatus comprising:
a memory operable to:
store a user account; and
store a points balance associated with the user account; and
a processor communicatively coupled to the memory and operable to:
determine a geographic location of a user associated with the user account;
communicate, based at least in part upon the geographic location, an offer for a product, wherein:
the product is associated with a points price; and
the points balance is at least equal to the points price;
receive a signal indicating acceptance of the offer, wherein the signal is associated with the user account; and
communicate a second signal indicating that the user can receive the product.

2. The apparatus of claim 1, wherein the processor is further operable to:
receive a user transaction associated with a transaction type and the user account;
determine a points value associated with the transaction type; and
add the points value to the points balance associated with the user account.

3. The apparatus of claim 2, wherein:
the memory is further operable to:
store a plurality of transaction types; and
store a points value for each transaction type; and
the processor is operable to determine the points value of the transaction type associated with the user transaction by:
determining the transaction type from the plurality of transaction types that matches the transaction type associated with the user transaction; and
determining the points value associated with the determined transaction type.

4. The apparatus of claim 2, wherein the user transaction is at least one of a bill payment, a money transfer, an ATM transaction, setting an appointment, a purchase, and a balance check.

5. The apparatus of claim 1, wherein the processor is further operable to communicate an alert in order to make the user aware of the offer.

6. The apparatus of claim 5, wherein the processor is further operable to communicate the alert in response to a determination that the geographic location of the user is within a predetermined distance of a store associated with the offer.

7. The apparatus of claim 1, wherein:
the memory is further operable to store data associated with previous user transactions associated with the user account; and
the processor is further operable to communicate an offer for a second product based at least in part upon the data associated with previous user transactions.

8. The apparatus of claim 1, wherein the product is at least one of a song, a movie, an eBook, a coupon, and a gift certificate.

9. The apparatus of claim 1, wherein the user account is associated with at least one of a credit card and a debit card.

10. The apparatus of claim 1, wherein the processor is further operable to communicate a third signal indicating that the offer cannot be accepted in response to a determination that the points price is greater than the points balance.

11. An apparatus comprising:
a processor; and
a memory storing instructions operable when executed by the processor to:
communicate a geographic location of the apparatus;
receive an offer for a product based at least in part upon the communicated geographic location, wherein the product is associated with a points price;
present, on a display, the offer and the points price;
detect a selection of the displayed offer indicating acceptance of the offer;
communicate a signal indicating acceptance of the offer; and
receive a second signal indicating that the acceptance is valid in response to a determination that a points balance is at least equal to the points price.

12. The apparatus of claim 11, wherein the instructions are further operable when executed by the processor to communicate a user transaction associated with a transaction type and a user account so that a points value associated with the transaction type may be added to a balance of the user account.

13. The apparatus of claim 12, wherein the user transaction is at least one of a bill payment, a money transfer, an ATM transaction, setting an appointment, a purchase, and a balance check.

14. The apparatus of claim 11, wherein the instructions are further operable when executed by the processor to:
receive an alert associated with the offer; and
present, on the display, in response to receiving the alert, a notification associated with the offer in order to make a user aware of the offer.

15. The apparatus of claim 14, wherein the alert is received in response to a determination that the geographic location of the user is within a predetermined distance of a store associated with the offer.

16. The apparatus of claim 11, wherein the instructions are further operable when executed by the processor to receive an offer for a second product based at least in part upon data associated with previous user transactions.

17. The apparatus of claim 11, wherein the product is at least one of a song, a movie, an eBook, a coupon, and a gift certificate.

18. The apparatus of claim 11, wherein the instructions are further operable when executed by the processor to receive a third signal indicating that the offer cannot be accepted in response to a determination that the points balance is less than the points price.

19. A method comprising:
storing a user account;
storing a points balance associated with the user account;
determining a geographic location of a user associated with the user account;
communicating, based at least in part upon the geographic location, an offer for a product, wherein:
the product is associated with a points price; and
the points balance is at least equal to the points price;
receiving a signal indicating acceptance of the offer, wherein the signal is associated with the user account; and
communicating a second signal indicating that the user can receive the product.

20. The method of claim 19 further comprising:
receiving a user transaction associated with a transaction type and the user account;
determining a points value associated with the transaction type; and
adding the points value to the points balance associated with the user account.

21. The method of claim 20 further comprising:
storing a plurality of transaction types;
storing a points value for each transaction type; and
wherein determining the points value of the transaction type associated with the user transaction comprises:
determining the transaction type from the plurality of transaction types that matches the transaction type associated with the user transaction; and
determining the points value associated with the determined transaction type.

22. The method of claim 20, wherein the user transaction is at least one of a bill payment, a money transfer, an ATM transaction, setting an appointment, a purchase, and a balance check.

23. The method of claim 19 further comprising communicating an alert in order to make the user aware of the offer.

24. The method of claim 23 further comprising communicating the alert in response to a determination that the geographic location of the user is within a predetermined distance of a store associated with the offer.

25. The method of claim 19 further comprising:
storing data associated with previous user transactions associated with the user account; and
communicating an offer for a second product based at least in part upon the data associated with previous user transactions.

26. The method of claim 19, wherein the product is at least one of a song, a movie, an eBook, a coupon, and a gift certificate.

27. The method of claim 19, wherein the user account is associated with at least one of a credit card and a debit card.

28. The method of claim 19 further comprising communicating a third signal indicating that the offer cannot be accepted in response to a determination that the points price is greater than the points balance.

29. A method comprising:
communicating a geographic location of the apparatus;
receiving an offer for a product based at least in part upon the communicated geographic location, wherein the product is associated with a points price;
presenting, on a display, the offer and the points price;
detecting a selection of the displayed offer indicating acceptance of the offer;
communicating a signal indicating acceptance of the offer; and
receiving a second signal indicating that the acceptance is valid in response to a determination that a points balance is at least equal to the points price.

30. The method of claim 29 further comprising communicating a user transaction associated with a transaction type and a user account so that a points value associated with the transaction type may be added to a balance of the user account.

31. The method of claim 30, wherein the user transaction is at least one of a bill payment, a money transfer, an ATM transaction, setting an appointment, a purchase, and a balance check.

32. The method of claim 29 further comprising:
receiving an alert associated with the offer; and
presenting, on the display, in response to receiving the alert, a notification associated with the offer in order to make a user aware of the offer.

33. The method of claim 32, wherein the alert is received in response to a determination that the geographic location of the user is within a predetermined distance of a store associated with the offer.

34. The method of claim 29 further comprising receiving an offer for a second product based at least in part upon data associated with previous user transactions.

35. The method of claim 29, wherein the product is at least one of a song, a movie, an eBook, a coupon, and a gift certificate.

36. The method of claim 29 further comprising receiving a third signal indicating that the offer cannot be accepted in response to a determination that the points balance is less than the points price.

37. One or more computer-readable non-transitory storage media embodying software that is operable when executed to:
communicate a geographic location of the apparatus;
receive an offer for a product based at least in part upon the communicated geographic location, wherein the product is associated with a points price;
present, on a display, the offer and the points price;
detect a selection of the displayed offer indicating acceptance of the offer;
communicate a signal indicating acceptance of the offer; and
receive a second signal indicating that the acceptance is valid in response to a determination that a points balance is at least equal to the points price.

38. The one or more computer-readable non-transitory storage media of claim 37 embodying software that is further operable when executed to communicate a user transaction associated with a transaction type and a user account so that a points value associated with the transaction type may be added to a balance of the user account.

39. The one or more computer-readable non-transitory storage media of claim 38, wherein the user transaction is at least one of a bill payment, a money transfer, an ATM transaction, setting an appointment, a purchase, and a balance check.

40. The one or more computer-readable non-transitory storage media of claim 37 embodying software that is further operable when executed to:
receive an alert associated with the offer; and
present, on the display, in response to receiving the alert, a notification associated with the offer in order to make a user aware of the offer.

41. The one or more computer-readable non-transitory storage media of claim 40, wherein the alert is received in response to a determination that the geographic location of the user is within a predetermined distance of a store associated with the offer.

42. The one or more computer-readable non-transitory storage media of claim 37 embodying software that is further operable when executed to receive an offer for a second product based at least in part upon data associated with previous user transactions.

43. The one or more computer-readable non-transitory storage media of claim 37, wherein the product is at least one of a song, a movie, an eBook, a coupon, and a gift certificate.

44. The one or more computer-readable non-transitory storage media of claim 37, embodying software that is further operable when executed to receive a third signal indicating that the offer cannot be accepted in response to a determination that the points balance is less than the points price.
